(19) United States
(12) Patent Application Publication
(10) Pub. No.: US 2022/0119564 A1
(43) Pub. Date: Apr. 21, 2022

(54) PROCESS TO PRODUCE A POLYMER AND POLYMER

(71) Applicant: BOREALIS AG, Vienna (AT)

(72) Inventors: Girish Suresh GALGALI, Linz (AT); John JAMIESON, Porvoo (FI)

(21) Appl. No.: 17/298,157

(22) PCT Filed: Nov. 29, 2019
(86) PCT No.: PCT/EP2019/083111

§ 371 Date: May 28, 2021

(30) Foreign Application Priority Data
Nov. 29, 2018 (EP) 18209289.0

(51) Int. Cl. C08F 210/16; C08L 23/08; C08F 2/00; C08F 2/34; C08F 210/08; C08F 210/14

(52) U.S. Cl. CPC C08F 210/16; C08L 23/0815; C08F 2/001; C08F 2/34; C08L 2203/16; C08F 210/14; C08L 2308/00; C08L 2314/06; C08L 2201/10; C08F 210/08

(57) ABSTRACT

The present invention relates to a process to produce a polymer, a corresponding polymer and a article comprising a polymer made by the process according to the invention.

The present invention relates to a process to produce a polymer, a corresponding polymer and a article comprising a polymer made by the process according to the invention.

Unimodal polyethylene (PE) polymers, for instance SSC products, are usually used for film application. Unimodal PE polymers have for instance good optical properties, like low haze, but for instance the melt processing of such polymers is not satisfactory in production point of view and may cause quality problems of the final product as well. Multimodal PE polymers with two or more different polymer components are better to process, but e.g. melt homogenisation of the multimodal PE may be problematic resulting to inhomogeniuos final product evidenced e.g. with high gel content of the final product.

EP1472298A of Borealis discloses multimodal PE polymer compositions having two different comonomers. The multimodal PE polymers are polymerised in the presence of a metallocene catalyst. Examples disclose multimodal PE polymer having two polymer components with, for instance, different type of comonomers. The publication does seem to define any range for the melt flow ratio, MFR₂₁/MFR₂ (FRR_{21/2}), of the final multimodal PE polymer, however said melt flow ratio of the exemplified polymers vary within the range of 38-55.

There is a continuous need to find multimodal PE polymers with different property balances for providing tailored solutions to meet the increasing demands of the end application producers e.g. for reducing the production costs and/or maintaining or even improving the end product properties, especially for example the stress at break and/or toughness and/or the balance between stiffness and toughness as well as optical properties, such as gloss and/or haze. Tailored polymer solutions are also needed to meet the requirements of continuously developing equipment technology in the end application field.

### DESCRIPTION OF THE INVENTION

The present invention is directed to a process for producing a polymer characterized in that a first ethylene polymer component (A) is obtained in a first polymerization zone by polymerization conducted in slurry in the presence of ethylene and hydrogen and the polymerization of a second ethylene polymer component (B) in a second polymerization zone is preferably conducted in gas phase in the presence of ethylene and a comonomer, to produce (a) a multimodal polymer of ethylene with at least one comonomer selected from alpha-olefins having from 4 to 10 carbon atoms,
which has
   a) MFR₂ of 0.5 to 10 g/10 min (according to ISO 1133 at 190° C. under 2.16 kg load),
   b) MFR₂₁/MFR₂ of 13 to 35 (MFR₂₁ at 190° C. under 21.6 kg load) and
   c) MWD of 5 or less;
which comprises at least
   an ethylene polymer component (A) and
   an ethylene polymer component (B),
and wherein the MFR₂ of the ethylene polymer component (A) is higher than the MFR₂ of the ethylene polymer component (B) and the MFR2 of of the ethylene polymer component (B) is <0.64 g/10 min according to ISO 1133 at 190° C. under 2.16 kg load.

The process according to the invention may especially be for producing a polymer for film applications, especially for film applications demanding high toughness and/or good optical properties.

In a process for producing a polymer according to the invention the MFR2 of of the ethylene polymer component (B) may be between 0.0001 and <0.64, preferably between 0.001 and 0.60, further preferred between 0.01 and 0.55, further preferred between 0.1 and 0.50 g/10 min according to ISO 1133 at 190° C. under 2.16 kg load.

In a process for producing a polymer according to the invention the first ethylene polymer component (A) may be obtained in a first polymerization zone by polymerization conducted in slurry in the presence of a second comonomer.

In a process for producing a polymer according to the invention the first polymerization zone may comprise at least one slurry loop reactors and the second polymerisation zone may comprise at least one gas phase reactor, preferably connected in series.

In a process for producing a polymer according to the invention the first polymerization zone may comprise two slurry loop reactors, preferably connected in series and/or further preferred whereby the ratio of second comonomer to ethylene in the first loop is higher than in the second loop.

In a process for producing a polymer according to the invention the first polymerization zone may comprise two slurry loop reactors connected in series, whereby hydrogen is added to the first slurry loop reactor and/or the second loop reactor, preferably only to the first loop reactor.

In a process for producing a polymer according to the invention the first polymerization zone may comprise two slurry loop reactors connected in series, whereby hydrogen is fed only to the first slurry loop reactor and both slurry loops reactors are otherwise run under the same conditions or different conditions, preferably under the same conditions.

In a process for producing a polymer according to the invention the polymerization of a second ethylene polymer component (B) in a second polymerization zone is preferably conducted in gas phase, so that the molecular weight is maximized and/or in the with no hydrogen fed to the second polymerization zone. That the molecular weight is maximized may mean for example especially that chain transfer agent, especially substantially no hydrogen or no hydrogen is fed to the second polymerization zone or that the polymerization in the second polymerization zone is carried out substantially in the absence of hydrogen or in the absence of hydrogen or in the absence of hydrogen added to the second polymerization zone.

In a process for producing a polymer according to the invention, the ethylene polymer component (A) may have a MFR₂ of 1 to 50 g/10 min, preferably of 1 to 40, more preferably of 1 to 30, g/10 min or wherein the ratio of the MFR₂ of ethylene polymer component (A) to the MFR₂ of the final multimodal polymer of ethylene (a) may be of 2 to 50, preferably of 5 to 40, preferably of 10 to 30.

In s process for producing a polymer according to the invention, a second comonomer may be used for producing ethylene polymer component (A) and the comonomer and the second comonomer may be at least two alpha-olefin comonomers having from 4 to 10 carbon atoms, preferably 1-butene and 1-hexene, further preferred wherein the alpha-olefin comonomer having from 4 to 10 carbon atoms of ethylene polymer component (A) may be different from the alpha-olefin comonomer having from 4 to 10 carbon atoms of ethylene polymer component (B), preferably wherein the second alpha-olefin comonomer having from 4 to 10 carbon atoms of ethylene polymer component (A) may be 1-butene and the alpha-olefin comonomer having from 4 to 10 carbon atoms of ethylene polymer component (B) may be 1-hexene.

In a process for producing a polymer according to the invention the ratio of [the amount (mol %) of alpha-olefin comonomer having from 4 to 10 carbon atoms comonomer present in ethylene polymer component (A)] to [the amount (mol %) of at least two alpha-olefin comonomers having from 4 to 10 carbon atoms of the final multimodal polymer of ethylene (a)] may be of 0.2 to 0.6, preferably of 0.24 to 0.5, more preferably the ethylene polymer component (A) may have lower amount (mol %) of comonomer than the ethylene polymer component (B).

In a process for producing a polymer according to the invention the amount (mol %) of alpha-olefin comonomer having from 4 to 10 carbon atoms present in the ethylene polymer component (A) may be of 0.03 to 5.0 mol %, preferably of 0.05 to 4.0, more preferably of 0.1 to 3.0, even more preferably of 0.1 to 2.0, mol %.

In a process for producing a polymer according to the invention the multimodal polymer of ethylene (a) may further be multimodal with respect to density, preferably the density of the ethylene polymer component (A) may be different, preferably higher, than the density of the ethylene polymer component (B).

In a process for producing a polymer according to the invention the density of the ethylene polymer component (A) may be of 925 to 950, preferably of 930 to 945, kg/m³ or wherein the density of the multimodal polymer of ethylene (a) is of 910 to 935, preferably of 915 to 930 or >912 to <925 kg/m³ or wherein the multimodal polymer of ethylene (a) may have MFR₂₁/MFR₂ of 13 to 30, preferably 15 to 30, or wherein the multimodal polymer of ethylene (a) may be multimodal with respect to MFR, type of the comonomer, comonomer content and density or wherein the multimodal polymer of ethylene (a), may have a the tensile modulus in machine direction (MD) of 200 to 350 MPa, preferably 210 to 330 MPa, when determined according to ISO 527-1 and ISO 527-3 and measured from a film sample (40 μm thickness) consisting of the polymer composition as described in the specification under “Determination methods” or wherein polymer composition, preferably the multimodal polymer of ethylene (a), may have a SHI_{2.7/210} of 1.5 to 7, preferably of 2 to 3.5, when determined according to the “Dynamic Shear Measurements” as defined in the specification under Determination methods.

In a process for producing a polymer according to the invention the multimodal polymer of ethylene (a) may be produced using a single site catalyst, preferably wherein the ethylene polymer components (A) and (B) of the polymer of ethylene (a) may be produced using same single site catalyst.

That a single-site catalyst is used in the polymerization of at least one of fractions (A) and/or (B) may thereby mean for example that at least one or preferably at least two or preferably all of the fractions (A) and/or (B) and/or the multimodal polymer (a) may have for example a MWD=Mw/Mn determined by GPC of 1.5 to 6.5, preferably 2 to 5.5, further preferred >2 to <5 or <4.5.

The present invention also concerns an article or film comprising the polymer composition produced using a process according the invention.

Term “multimodal” in context of polymer of ethylene (a) means herein multimodality with respect to melt flow rate (MFR) of the ethylene polymer components (A) and (B), i.e. the ethylene polymer components (A) and (B) have different MFR values. The multimodal polymer of ethylene (a) can have further multimodality with respect to one or more further properties between the ethylene polymer components (A) and (B), as will be described later below.

A polymer composition as mentioned herein is also referred herein shortly as “polymer composition”.

The “(a) a multimodal polymer of ethylene with at least two different comonomers selected from alpha-olefins having from 4 to 10 carbon atoms” or, respectively, “the multimodal polymer of ethylene (a)” as defined above, below or in claims is also referred herein shortly as “polymer of ethylene (a)”.

The ethylene polymer component (A) and the ethylene polymer component (B), when both mentioned, are also be referred as “ethylene polymer component (A) and (B)”.

Unexpectedly the invention provides a flexibility to tailor polymer structure to be the most suitable for selected application.

Surprisingly the invention may thereby provides, for example an advantageous balance between processability, indicated e.g. as markedly reduced extruder pressure compared to unimodal polymers, combined with improved homogeneity, indicated e.g. as low content of gels compared to “broader” multimodal ethylene polymers.

Preferably in addition to above excellent property balance achieved with the invention also concerns the mechanical properties, which may be improved, allowing for instance a higher stiffness (expressed e.g. as higher tensile modulus in machine direction (MD)), compared e.g. to unimodal ethylene polymer having the same final density.

Further preferably, the invention may contribute to excellent sealing properties, indicated e.g. as low hot tack temperature at maximum hot tack force. The polymer composition also provides sealing initiation even in low temperatures.

Moreover, with the property balance of the invention may provides good optical properties, like very good haze values.

The obtained property balance is highly desirable e.g. for film applications.

The preferable embodiments, properties and subgroups of the process, polymer composition, polymer of ethylene (a) and the ethylene polymer components (A) and (B) thereof including the preferable ranges thereof, are independently generalisable so that they can be used in any order or combination to further define the preferable embodiments of the process, polymer composition and the article.

### Polymer Composition, Polymer of Ethylene (a) as Well as Ethylene Polymer Component (A) and Ethylene Polymer Component (B)

As already mentioned above, the polymer of ethylene (a) is referred herein as “multimodal”, since the ethylene polymer component (A) and the ethylene polymer component (B) have been produced under different polymerization conditions resulting in different Melt Flow Rates (MFR, e.g. MFR₂). I.e. the polymer composition is multimodal at least with respect to difference in MFR of the two ethylene polymer components (A) and (B). The term “multi” includes “bimodal” composition consisting of two components having the difference in said MFR.

Preferably, the ethylene polymer component (A) has a MFR₂ of 1 to 50 g/10 min, preferably of 1 to 40, more preferably of 1 to 30, more preferably of 2 to 20, more preferably of 2 to 15, even more preferably of 2 to 10, g/10 min. More preferably, the ethylene polymer component (A) has higher MFR₂ than ethylene polymer component (B).

Even more preferably, the ratio of the MFR₂ of ethylene polymer component (A) to the MFR₂ of the final multimodal polymer of ethylene (a) is of 2 to 50, preferably of 5 to 40, preferably of 10 to 30, more preferably of 10 to 25, more preferably of 15 to 25.

Preferably, MFR₂ of the polymer composition, preferably the polymer of ethylene (a), is preferably of 0.5 to 7, preferably of 0.5 to 5, g/10 min. Preferably, the polymer composition, preferably the polymer of ethylene (a), has MFR₂₁/MFR₂ of 13 to 30, preferably of 15 to 30, more preferably of 15 to 25.

If the MFR₂ of ethylene polymer components, e.g. component (B), can not be measured, because it cannot be isolated from the mixture of at least ethylene polymer components (A) or (B), then it can be calculated (MI₂ below) using so called Hagström equation (Hagström, The Polymer Processing Society, Europe/Africa Region Meeting, Gothenburg, Sweden, Aug. 19-21, 1997):

$${MI}_{b} = {( w \cdot {MI}_{1}^{- \frac{{w}^{- b}}{a}} + ( 1 - w ) \cdot {MI}_{2}^{- \frac{{w}^{- b}}{a}} )}^{- a \cdot {w}^{b}} \qquad ( eq . 3 )$$

According to said Hagström, in said equation (eq. 3), a=5.2 and b=0.7 for MFR₂. Furthermore, w is the weight fraction of the other ethylene polymer component, e.g. component (A), having higher MFR. The ethylene polymer component (A) can thus be taken as the component 1 and the ethylene polymer component (B) as the component 2. MI_{b} is the MFR₂ of the final polymer of ethylene (a). The MFR₂ of the ethylene polymer component (B) (MI₂) can then be solved from equation 1 when the MFR₁ of the ethylene polymer component (A) (MI₁) and the final polymer of ethylene (a) (MI_{b}) are known.

The at least two alpha-olefin comonomers having from 4 to 10 carbon atoms of the polymer of ethylene (a) are preferably 1-butene and 1-hexene.

Naturally, in addition to multimodality with respect to, i.e. difference between, the MFR of the ethylene polymer components (A) and (B), the polymer of ethylene (a) of polymer composition of the invention can also be multimodal e.g. with respect to one or both of the two further properties:
multimodality with respect to, i.e. difference between,
   the comonomer type or the comonomer content(s) present in the ethylene polymer components (A) and (B), or both the type and content(s) of comonomers present in the ethylene polymer components (A) and (B); and/or
   the density of the ethylene polymer components (A) and (B).

Preferably, the multimodal polymer of ethylene (a) of the polymer composition is further multimodal with respect to comonomer type and/or comonomer content (mol-%), preferably wherein the alpha-olefin comonomer having from 4 to 10 carbon atoms of ethylene polymer component (A) is different from the alpha-olefin comonomer having from 4 to 10 carbon atoms of ethylene polymer component (B), preferably wherein the alpha-olefin comonomer having from 4 to 10 carbon atoms of ethylene polymer component (A) is 1-butene and the alpha-olefin comonomer having from 4 to 10 carbon atoms of ethylene polymer component (B) is 1-hexene.

Preferably, the ratio of [the amount (mol %) of alpha-olefin comonomer having from 4 to 10 carbon atoms comonomer present in ethylene polymer component (A)] to [the amount (mol %) of at least two alpha-olefin comonomers having from 4 to 10 carbon atoms of the final multimodal polymer of ethylene (a)] is of 0.2 to 0.6, preferably of 0.24 to 0.5, more preferably the ethylene polymer component (A) has lower amount (mol %) of comonomer than the ethylene polymer component (B).

The comonomer content of component (A) and (B) can be measured, or, in case, and preferably, one of the components is produced first and the other thereafter in the presence of the first produced in so called multistage process, then the comonomer content of the first produced component, e.g. component (A), can be measured and the comonomer content of the other component, e.g. component (B), can be calculated according to following formula:

Comonomer content (mol-%) in component B=(comonomer content (mol-%) in final product−(weight fraction of component A*comonomer content (mol-%) in component A))/(weight fraction of component B)

Preferably, the amount (mol %) of alpha-olefin comonomer having from 4 to 10 carbon atoms present in the ethylene polymer component (A) is of 0.03 to 5.0 mol %, preferably of 0.05 to 4.0, more preferably of 0.1 to 3.0, even more preferably of 0.1 to 2.0, more preferably of 0.15 to 1.5, even more preferably of 0.15 to 1.0, mol %.

More preferably, the total amount of comonomers present in the multimodal polymer of ethylene (a) is of 0.5 to 10 mol %, preferably of 1.0 to 8, more preferably of 1.0 to 5, more preferably of 1.5 to 5.0, mol %.

The further specific multimodality, i.e. the difference between, the comonomer type and comonomer content between the ethylene polymer component (A) and the ethylene polymer component (B) further contributes to highly advantageous sealing properties, e.g. to improved hot tack properties as mentioned above and preferably also to the excellent sealing initiation temperature even in low temperatures. Also the optical properties, like haze, are in advantageous level.

Even more preferably the multimodal polymer of ethylene (a) of the polymer composition is further multimodal with respect to difference in density between the ethylene polymer component (A) and ethylene polymer component (B). Preferably, the density of ethylene polymer component (A) is different, preferably higher, than the density of the ethylene polymer component (B). More preferably the density of the ethylene polymer component (A) is of 925 to 950, preferably of 930 to 945, kg/m³.

The multimodal polymer of ethylene (a) is preferably a linear low density polyethylene (LLDPE) which has a well known meaning. Even more preferably the density of the multimodal polymer of ethylene (a), preferably of the polymer composition, is of 910 to 935, preferably of 915 to 930 or >912 to <925 kg/m³.

The multimodality with respect to density further contributes to the beneficial mechanical properties of the polymer composition.

Additionally, the polymer of ethylene (a) of the polymer composition can also be multimodal with respect to, i.e. have difference between, the (weight average) molecular weight of the ethylene polymer components (A) and (B). The multimodality re weight average molecular weight means that the form of the molecular weight distribution curve, i.e. the appearance of the graph of the polymer weight fraction as function of its molecular weight, of such a multimodal polyethylene will show two or more maxima or at least be distinctly broadened in comparison with the curves for the individual components.

More preferably the multimodal polymer of ethylene (a) is multimodal at least with respect to, i.e. has a difference between, the MFR₂, the comonomer type and the comonomer content (mol %), as well as with respect to, i.e. has a difference between, the density of the ethylene polymer component (A) and ethylene polymer component (B), as defined above, below or claims including any of the preferable ranges or embodiments of the polymer composition.

Most preferably the polymer composition of the invention, as defined above, below or in claims, comprises a multimodal polymer of ethylene (a) comprising, preferably consisting of, an ethylene polymer component (A) and an ethylene polymer component (B), wherein
the ethylene polymer component (A) has higher MFR₂ than ethylene polymer component (B);
   more preferably, the ethylene polymer component (A) has MFR₂ of 1 to 50 g/10 min, preferably of 1 to 40, more preferably of 1 to 30, more preferably of 2 to 20, more preferably of 2 to 15, even more preferably of 2 to 10, g/10 min;
   even more preferably, the ratio of the MFR₂ of ethylene polymer component (A) to the MFR₂ of the final multimodal polymer of ethylene (a) is of 2 to 50, preferably of 5 to 40, preferably of 10 to 30, more preferably of 10 to 25, more preferably of 15 to 25;
      and wherein
the ethylene polymer component (A) has different comonomer than the ethylene polymer (B);
   more preferably, the ethylene polymer component (A) has lower amount (mol %) of comonomer than the ethylene polymer component (B), even more preferably, the ratio of [the amount (mol %) of alpha-olefin comonomer having from 4 to 10 carbon atoms comonomer present in ethylene polymer component (A)] to [the amount (mol %) of at least two alpha-olefin comonomers having from 4 to 10 carbon atoms of the final multimodal polymer of ethylene (a)] is of 0.2 to 0.6, preferably of 0.25 to 0.5;
   even more preferably, wherein the alpha-olefin comonomer having from 4 to 10 carbon atoms of ethylene polymer component (A) is 1-butene and the alpha-olefin comonomer having from 4 to 10 carbon atoms of ethylene polymer component (B) is 1-hexene;
      and wherein
the ethylene polymer component (A) has different, preferably higher, density than the density of the ethylene polymer component (B);
   more preferably density of the multimodal polymer of ethylene (a), preferably of the polymer composition, is of 910 to 935, preferably of 915 to 930 or >912 to <925 kg/m³;
   even more preferably the density of the ethylene polymer component (A) is of 925 to 950, preferably of 930 to 945, kg/m³.

The polymer composition, preferably the multimodal polymer of ethylene (a), has preferably a shear thinning value, SHI_{2.7/210}, of 1.5 to 7, preferably of 2 to 3.5, when determined according to the “Dynamic Shear Measurements” as defined below under Determination methods.

The polymer composition, preferably the multimodal polymer of ethylene (a), has preferably a tensile modulus in machine direction (MD) of 200 to 350 MPa, preferably 210 to 330 MPa, when determined according to ISO 527-1 and ISO 527-3 and measured from a film sample (40 μm thickness) consisting of the polymer composition, as described below under “Determination methods”.

The polymer composition, preferably the multimodal polymer of ethylene (a), has preferably a following correlation between tensile modulus in MD direction for 40 μm film and Hot tack temperature (lowest temperature to get maximum Hot tack force):

Hot tack temperature <0.0794 Tensile modulus in MD+83.

The determination of tensile modulus in MD and Hot tack temperature are defined as described below under “Determination methods”.

The polymer composition has preferably a Hot tack temperature of less than 112° C. when measured according to ASTM F 1921-98 (2004), method B and measured from a film sample (40 μm thickness) consisting of the polymer composition as described above under “Determination methods”. Preferably the Hot tack temperature is 80° C. or more. More preferably the Hot tack temperature is of 111 to 85° C.

Further preferably, the polymer composition has a Hot tack (maximum Hot tack force) of 1.95 N or more, when measured according to ASTM F 1921-98 (2004), method B and measured from a film sample (40 μm thickness) consisting of the polymer composition as described above under “Determination methods”. Preferably the Hot tack is up to 5.0 N. More preferably the Hot tack is of 2.1 to 5.0 N.

Preferably, the multimodal polymer of ethylene (a) comprises the ethylene polymer component (A) in an amount of 30 to 70, preferably of 40 to 60, more preferably of 35 to 50, more preferably 40 to 50, wt % and the ethylene polymer component (B) in an amount of 70 to 30, preferably of 60 to 40, more preferably of 50 to 65, more preferably 50 to 60, wt %, based on the total amount (100 wt %) of the polymer of ethylene (a). Most preferably, the polymer of ethylene (a) consists of the ethylene polymer components (A) and (B) as the sole polymer components. Accordingly, the split between ethylene polymer component (A) to ethylene polymer component (B) is of (30 to 70):(70 to 30) preferably of (40 to 60):(60 to 40), more preferably of (35 to 50):(65 to 50), more preferably of (40 to 50):(50 to 60), wt %.

The polymer composition may contain further polymer components and optionally additives and/or fillers. It is noted herein that additives may be present in the polymer of ethylene (a) and/or mixed with the polymer of ethylene (a) e.g. in a compounding step for producing the polymer composition. In case the polymer composition contains further polymer components, then the amount of the further polymer component(s) typically varies between 3 to 20 wt % based on the combined amount of the polymer of ethylene (a) and the other polymer component(s).

The optional additives and fillers and the used amounts thereof are conventional in the field of film applications. Examples of such additives are, among others, antioxidants, process stabilizers, UV-stabilizers, pigments, fillers, antistatic additives, antiblock agents, nucleating agents, acid scavengers as well as polymer processing agent (PPA).

It is understood herein that any of the additives and/or fillers can optionally be added in so called master batch which comprises the respective additive(s) together with a carrier polymer. In such case the carrier polymer is not calculated to the polymer components of the polymer composition, but to the amount of the respective additive(s), based on the total amount of polymer composition (100 wt %).

Preferably the polymer composition comprises at least 80 wt % of polymer of ethylene (a) based on the total amount (100 wt %) of the polymer composition and optionally, and preferably, additives. It is noted herein, that the polymer of ethylene (a) may optionally comprise a prepolymer component in an amount up to 20 wt % which has a well-known meaning in the art. In such case the prepolymer component is calculated in one of the ethylene polymer components (A) or (B), preferably in an amount of the ethylene polymer component (A), based on the total amount of the polymer of ethylene (a).

Accordingly, the multimodal polymer of ethylene (a) is preferably produced using a coordination catalyst. More preferably, the ethylene polymer components (A) and (B) of the polymer of ethylene (a) are preferably produced using a single site catalyst, which includes metallocene catalyst and non-metallocene catalyst, which all terms have a well-known meaning in the art. The term “single site catalyst” means herein the catalytically active metallocene compound or complex combined with a cocatalyst. The metallocene compound or complex is referred herein also as organometallic compound (C).

The organometallic compound (C) comprises a transition metal (M) of Group 3 to 10 of the Periodic Table (IUPAC 2007) or of an actinide or lanthanide.

The term “an organometallic compound (C)” in accordance with the present invention includes any metallocene or non-metallocene compound of a transition metal which bears at least one organic (coordination) ligand and exhibits the catalytic activity alone or together with a cocatalyst. The transition metal compounds are well known in the art and the present invention covers compounds of metals from Group 3 to 10, e.g. Group 3 to 7, or 3 to 6, such as Group 4 to 6 of the Periodic Table, (IUPAC 2007), as well lanthanides or actinides.

In an embodiment the organometallic compound (C) has the following formula (I):

(L)ₘRₙMX_{q} (I)

wherein
“M” is a transition metal (M) transition metal (M) of Group 3 to 10 of the Periodic Table (IUPAC 2007),
each “X” is independently a monoanionic ligand, such as a 6-ligand,
each “L” is independently an organic ligand which coordinates to the transition metal “M”,
“R” is a bridging group linking said organic ligands (L),
“m” is 1, 2 or 3, preferably 2
“n” is 0, 1 or 2, preferably 1,
“q” is 1, 2 or 3, preferably 2 and
m+q is equal to the valency of the transition metal (M).
“M” is preferably selected from the group consisting of zirconium (Zr), hafnium (Hf), or titanium (Ti), more preferably selected from the group consisting of zirconium (Zr) and hafnium (Hf). “X” is preferably a halogen, most preferably Cl.

Most preferably the organometallic compound (C) is a metallocene complex which comprises a transition metal compound, as defined above, which contains a cyclopentadienyl, indenyl or fluorenyl ligand as the substituent “L”. Further, the ligands “L” may have substituents, such as alkyl groups, aryl groups, arylalkyl groups, alkylaryl groups, silyl groups, siloxy groups, alkoxy groups or other heteroatom groups or the like. Suitable metallocene catalysts are known in the art and are disclosed, among others, in WO-A-95/12622, WO-A-96/32423, WO-A-97/28170, WO-A-98/32776, WO-A-99/61489, WO-A-03/010208, WO-A-03/051934, WO-A-03/051514, WO-A-2004/085499, EP-A-1752462 and EP-A-1739103

Most preferred single site catalyst is a metallocene catalyst which means the catalytically active metallocene complex, as defined above, together with a cocatalyst, which is also known as an activator. Suitable activators are metal alkyl compounds and especially aluminium alkyl compounds known in the art. Especially suitable activators used with metallocene catalysts are alkylaluminium oxy-compounds, such as methylalumoxane (MAO), tetraisobutylalumoxane (TIBAO) or hexaisobutylalumoxane (HIBAO).

A suitable single site catalyst may thereby especially be as a single site catalyst prepared as follows: 130 grams of a metallocene complex bis(1-methyl-3-n-butylcyclopentadienyl) zirconium (IV) dichloride (CAS no. 151840-68-5), and 9.67 kg of a 30% solution of commercial methylalumoxane (MAO) in toluene were combined and 3.18 kg dry, purified toluene was added. The thus obtained complex solution was added onto 17 kg silica carrier Sylopol 55 SJ (supplied by Grace) by very slow uniform spraying over 2 hours. The temperature was kept below 30° C. The mixture was allowed to react for 3 hours after complex addition at 30° C.

More preferably the ethylene polymer components (A) and (B) of the polymer of ethylene (a) are produced using, i.e. in the presence of, the same metallocene catalyst.

The multimodal polymer of ethylene (a) may be produced in any suitable polymerization process known in the art. Into the polymerization zone is also introduced ethylene, optionally an inert diluent, and optionally hydrogen and/or comonomer. The ethylene polymer component (A) is preferably produced in a first polymerization zone and the ethylene polymer component (B) is produced in a second polymerization zone. The first polymerization zone and the second polymerization zone may be connected in any order, i.e. the first polymerization zone may precede the second polymerization zone, or the second polymerization zone may precede the first polymerization zone or, alternatively, polymerization zones may be connected in parallel. However, it is preferred to operate the polymerization zones in cascaded mode. The polymerization zones may operate in slurry, solution, or gas phase conditions or their combinations. Suitable processes comprising cascaded slurry and gas phase polymerization stages are disclosed, among others, in WO-A-92/12182 and WO-A-96/18662.

It is often preferred to remove the reactants of the preceding polymerization stage from the polymer before introducing it into the subsequent polymerization stage. This is preferably done when transferring the polymer from one polymerization stage to another.

The catalyst may be transferred into the polymerization zone by any means known in the art. For example, it is possible to suspend the catalyst in a diluent and maintain it as homogeneous slurry, to mix the catalyst with a viscous mixture of grease and oil and feed the resultant paste into the polymerization zone or to let the catalyst settle and introduce portions of thus obtained catalyst mud into the polymerization zone.

The polymerization, preferably of the ethylene polymer component (A), in the first polymerization zone is preferably conducted in slurry. Then the polymer particles formed in the polymerization, together with the catalyst fragmented and dispersed within the particles, are suspended in the fluid hydrocarbon. The slurry is agitated to enable the transfer of reactants from the fluid into the particles.

The polymerization usually takes place in an inert diluent, typically a hydrocarbon diluent such as methane, ethane, propane, n-butane, isobutane, pentanes, hexanes, heptanes, octanes etc., or their mixtures. Preferably the diluent is a low-boiling hydrocarbon having from 1 to 4 carbon atoms or a mixture of such hydrocarbons and preferred diluent is propane.

The ethylene content in the fluid phase of the slurry may be from 2 to about 50% by mole, preferably from about 2 to about 20% by mole and in particular from about 3 to about 12% by mole.

The temperature in the slurry polymerization is typically from 50 to 115° C., preferably from 60 to 110° C. and in particular from 70 to 100° C. The pressure is from 1 to 150 bar, preferably from 10 to 100 bar.

The slurry polymerization may be conducted in any known reactor used for slurry polymerization. Such reactors include a continuous stirred tank reactor and a loop reactor. It is especially preferred to conduct the polymerization in a slurry loop reactor. In such reactors the slurry is circulated with a high velocity along a closed pipe by using a circulation pump. Loop reactors are generally known in the art and examples are given, for instance, in U.S. Pat. Nos. 4,582,816, 3,405,109, 3,324,093, EP-A-479186 and U.S. Pat. No. 5,391,654.

It is sometimes advantageous to conduct the slurry polymerization above the critical temperature and pressure of the fluid mixture. Such operation is described in U.S. Pat. No. 5,391,654. In such operation the temperature is typically from 85 to 110° C., preferably from 90 to 105° C. and the pressure is from 40 to 150 bar, preferably from 50 to 100 bar.

The slurry may be withdrawn from the reactor either continuously or intermittently. A preferred way of intermittent withdrawal is the use of settling legs where slurry is allowed to concentrate before withdrawing a batch of the concentrated slurry from the reactor. The continuous withdrawal is advantageously combined with a suitable concentration method, e.g. as disclosed in EP-A-1310295 and EP-A-1591460.

Hydrogen may be fed into the reactor to control the molecular weight of the polymer as known in the art. Furthermore, one or more alpha-olefin comonomers are added into the reactor e.g. to control the density of the polymer product. The actual amount of such hydrogen and comonomer feeds depends on the catalyst that is used and the desired melt index (or molecular weight) and density (or comonomer content) of the resulting polymer.

The polymerization, preferably of the ethylene polymer component (B), in the second polymerization zone is preferably conducted in gas phase, preferably in a gas phase reactor, further preferred in a gas phase fluidized bed reactor, in a gas phase fast fluidized bed reactor or in a gas phase settled bed reactor or in any combination of these. The polymerization in the second polymerization zone is more preferably conducted in a fluidized bed gas phase reactor, wherein ethylene is polymerized together with at least one comonomer in the presence of a polymerization catalyst and, preferably in the presence of the reaction mixture from the first polymerization zone comprising the ethylene polymer component (A) in an upwards moving gas stream. The reactor typically contains a fluidized bed comprising the growing polymer particles containing the active catalyst located above a fluidization grid.

The polymer bed is fluidized with the help of the fluidization gas comprising the olefin monomer, eventual comonomer(s), optional chain growth controllers or chain transfer agents, such as hydrogen, and eventual inert gas. The fluidization gas is introduced into an inlet chamber at the bottom of the reactor. One or more of the above-mentioned components may be continuously added into the fluidization gas to compensate for losses caused, among other, by reaction or product withdrawal.

The fluidization gas passes through the fluidized bed. The superficial velocity of the fluidization gas must be higher that minimum fluidization velocity of the particles contained in the fluidized bed, as otherwise no fluidization would occur. On the other hand, the velocity of the gas should be lower than the onset velocity of pneumatic transport, as otherwise the whole bed would be entrained with the fluidization gas.

When the fluidization gas is contacted with the bed containing the active catalyst the reactive components of the gas, such as monomers and chain transfer agents, react in the presence of the catalyst to produce the polymer product. At the same time the gas is heated by the reaction heat. The unreacted fluidization gas is removed from the top of the reactor and cooled in a heat exchanger to remove the heat of reaction. The gas is cooled to a temperature which is lower than that of the bed to prevent the bed from heating because of the reaction. It is possible to cool the gas to a temperature where a part of it condenses. When the liquid droplets enter the reaction zone they are vaporised. The vaporisation heat then contributes to the removal of the reaction heat. This kind of operation is called condensed mode and variations of it are disclosed, among others, in WO-A-2007/025640, U.S. Pat. No. 4,543,399, EP-A-699213 and WO-A-94/25495. It is also possible to add condensing agents into the recycle gas stream, as disclosed in EP-A-696293. The condensing agents are non-polymerizable components, such as n-pentane, isopentane, n-butane or isobutane, which are at least partially condensed in the cooler.

The gas is then compressed and recycled into the inlet chamber of the reactor. Prior to the entry into the reactor fresh reactants are introduced into the fluidization gas stream to compensate for the losses caused by the reaction and product withdrawal. It is generally known to analyze the composition of the fluidization gas and introduce the gas components to keep the composition constant. The actual composition is determined by the desired properties of the product and the catalyst used in the polymerization.

The catalyst may be introduced into the reactor in various ways, either continuously or intermittently. Where the gas phase reactor is a part of a reactor cascade the catalyst is usually dispersed within the polymer particles from the preceding polymerization stage. The polymer particles may be introduced into the gas phase reactor as disclosed in EP-A-1415999 and WO-A-00/26258. Especially if the preceding reactor is a slurry reactor it is advantageous to feed the slurry directly into the fluidized bed of the gas phase reactor as disclosed in EP-A-887379, EP-A-887380, EP-A-887381 and EP-A-991684.

The polymeric product may be withdrawn from the gas phase reactor either continuously or intermittently. Combinations of these methods may also be used. Continuous withdrawal is disclosed, among others, in WO-A-00/29452. Intermittent withdrawal is disclosed, among others, in U.S. Pat. No. 4,621,952, EP-A-188125, EP-A-250169 and EP-A-579426.

Also antistatic agent(s), such as water, ketones, aldehydes and alcohols, may be introduced into the gas phase reactor if needed. The reactor may also include a mechanical agitator to further facilitate mixing within the fluidized bed.

Typically the fluidized bed polymerization reactor is operated at a temperature within the range of from 50 to 100° C., preferably from 65 to 90° C. The pressure is suitably from 10 to 40 bar, preferably from 15 to 30 bar.

The polymerization of at least ethylene polymer component (A) and ethylene polymer component (B) in the first and second polymerization zones may be preceded by a prepolymerization step. The purpose of the prepolymerization is to polymerize a small amount of polymer onto the catalyst at a low temperature and/or a low monomer concentration. By prepolymerization it is possible to improve the performance of the catalyst in slurry and/or modify the properties of the final polymer. The prepolymerization step may be conducted in slurry or in gas phase. Preferably prepolymerization is conducted in slurry, preferably in a slurry loop reactor. The prepolymerization is then preferably conducted in an inert diluent, preferably the diluent is a low-boiling hydrocarbon having from 1 to 4 carbon atoms or a mixture of such hydrocarbons.

The temperature in the prepolymerization step is typically from 0 to 90° C., preferably from 20 to 80° C. and more preferably from 40 to 70° C.

The pressure is not critical and is typically from 1 to 150 bar, preferably from 10 to 100 bar. The catalyst components are preferably all introduced to the prepolymerization step. Preferably the reaction product of the prepolymerization step is then introduced to the first polymerization zone. Also preferably, as mentioned above, the prepolymer component is calculated to the amount of the ethylene polymer component (A).

It is within the knowledge of a skilled person to adapt the polymerization conditions in each step as well as feed streams and resident times to obtain the claimed multimodal polymer of ethylene (a).

The multimodal polymer of ethylene (a) comprising at least, and preferably solely, the ethylene polymer components (A) and (B) obtained from the second polymerization zone, which is preferably a gas phase reactor as described above, is the subjected to conventional post reactor treatment to remove i.a. the unreacted components.

Thereafter, typically, the obtained polymer is extruded and pelletized. The extrusion may be conducted in the manner generally known in the art, preferably in a twin screw extruder. One example of suitable twin screw extruders is a co-rotating twin screw extruder. Those are manufactured, among others, by Coperion or Japan Steel Works. Another example is a counter-rotating twin screw extruder. Such extruders are manufactured, among others, by Kobe Steel and Japan Steel Works. Before the extrusion at least part of the desired additives, as mentioned above, are preferably mixed with the polymer. The extruders typically include a melting section where the polymer is melted and a mixing section where the polymer melt is homogenised. Melting and homogenisation are achieved by introducing energy into the polymer. Suitable level of specific energy input (SEI) is from about 150 to about 450 kWh/ton polymer, preferably from 175 to 350 kWh/ton.

### Determination Methods

Unless otherwise stated in the description or in the experimental part, the following methods were used for the property determinations of the polymer composition, polar polymer and/or any sample preparations thereof as specified in the text or experimental part.

### Melt Flow Rate

The melt flow rate (MFR) is determined according to ISO 1133 and is indicated in g/10 min. The MFR is an indication of the flowability, and hence the processability, of the polymer. The higher the melt flow rate, the lower the viscosity of the polymer. The MFR is determined at 190° C. for polyethylene. MFR may be determined at different loadings such as 2.16 kg (MFR₂), 5 kg (MFR₅) or 21.6 kg (MFR₂₁).

### Density

Density of the polymer was measured according to ASTM; D792, Method B (density by balance at 23° C.) on compression moulded specimen prepared according to EN ISO 1872-2 (February 2007) and is given in kg/m³.

### Molecular Weights, Molecular Weight Distribution (Mn, Mw, MWD)—GPC

A PL 220 (Agilent) GPC equipped with a refractive index (RI), an online four capillary bridge viscometer (PL-BV 400-HT), and a dual light scattering detector (PL-LS 15/90 light scattering detector) with a 15° and 90° angle was used. 3× Olexis and 1× Olexis Guard columns from Agilent as stationary phase and 1,2,4-trichlorobenzene (TCB, stabilized with 250 mg/L 2,6-Di tert butyl-4-methyl-phenol) as mobile phase at 160° C. and at a constant flow rate of 1 mL/min was applied. 200 μL of sample solution were injected per analysis. All samples were prepared by dissolving 8.0-12.0 mg of polymer in 10 mL (at 160° C.) of stabilized TCB (same as mobile phase) for 2.5 hours for PP or 3 hours for PE at 160° C. under continuous gentle shaking. The injected concentration of the polymer solution at 160° C. (c_{160° C.}) was determined in the following way.

$${c}_{16 {0}^{∘} C} = \frac{{w}_{25}}{{V}_{25}} * \text{0,8772}$$

With: w₂₅ (polymer weight) and V₂₅ (Volume of TCB at 25° C.).

The corresponding detector constants as well as the inter detector delay volumes were determined with a narrow PS standard (MWD=1.01) with a molar mass of 132900 g/mol and a viscosity of 0.4789 dl/g. The corresponding dn/dc for the used PS standard in TCB is 0.053 cm³/g. The calculation was performed using the Cirrus Multi-Offline SEC-Software Version 3.2 (Agilent). The molar mass at each elution slice was calculated by using the 15° light scattering angle. Data collection, data processing and calculation were performed using the Cirrus Multi SEC-Software Version 3.2. The molecular weight was calculated using the option in the Cirrus software “use LS 15 angle” in the field “sample calculation options subfield slice MW data from”. The dn/dc used for the determination of molecular weight was calculated from the detector constant of the RI detector, the concentration c of the sample and the area of the detector response of the analysed sample. This molecular weight at each slice is calculated in the manner as it is described by C. Jackson and H. G. Barth (C. Jackson and H. G. Barth, “Molecular Weight Sensitive Detectors” in: Handbook of Size Exclusion Chromatography and related techniques, C.-S. Wu, 2^{nd} ed., Marcel Dekker, New York, 2004, p. 103) at low angle. For the low and high molecular region in which less signal of the LS detector or RI detector respectively was achieved a linear fit was used to correlate the elution volume to the corresponding molecular weight. Depending on the sample the region of the linear fit was adjusted.

Molecular weight averages (Mz, Mw and Mn), Molecular weight distribution (MWD) and its broadness, described by polydispersity index, PDI=Mw/Mn (wherein Mn is the number average molecular weight and Mw is the weight average molecular weight) were determined by Gel Permeation Chromatography (GPC) according to ISO 16014-4:2003 and ASTM D 6474-99 using the following formulas:

$$\begin{matrix}{M}_{n} = \frac{{\sum }_{i = 1}^{N} {A}_{i}}{Σ ( {A}_{i} / {M}_{i} )} & ( 1 ) \\ {M}_{w} = \frac{{\sum }_{i = 1}^{N} ( {A}_{i} x {M}_{i} )}{Σ ( {A}_{i} / {M}_{i} )} & ( 2 ) \\ {M}_{z} = \frac{{\sum }_{i = 1}^{N} ( {A}_{i} x {M}_{i}^{2} )}{Σ ( {A}_{i} / {M}_{i} )} & ( 3 )\end{matrix}$$

For a constant elution volume interval ΔVᵢ, where Aᵢ and Mᵢ are the chromatographic peak slice area and polyolefin molecular weight (MW) determined by GPC-LS.

### Comonomer Contents:

### Quantification of Microstructure by NMR Spectroscopy

Quantitative nuclear-magnetic resonance (NMR) spectroscopy was used to quantify the comonomer content of the polymers.

Quantitative ¹³C {¹H} NMR spectra recorded in the molten-state using a Bruker Advance III 500 NMR spectrometer operating at 500.13 and 125.76 MHz for ¹H and ¹³C respectively. All spectra were recorded using a ¹³C optimised 7 mm magic-angle spinning (MAS) probehead at 150° C. using nitrogen gas for all pneumatics. Approximately 200 mg of material was packed into a 7 mm outer diameter zirconia MAS rotor and spun at 4 kHz. This setup was chosen primarily for the high sensitivity needed for rapid identification and accurate quantification. {klimke06, parkinson07, castignolles09} Standard single-pulse excitation was employed utilising the NOE at short recycle delays {pollard04, klimke06} and the RS-HEPT decoupling scheme {fillip05, griffin07}. A total of 1024 (1k) transients were acquired per spectra.

Quantitative ¹³C {¹H} NMR spectra were processed, integrated and relevant quantitative properties determined from the integrals. All chemical shifts are internally referenced to the bulk methylene signal (δ+) at 30.00 ppm.

The amount of ethylene was quantified using the integral of the methylene (δ+) sites at 30.00 ppm accounting for the number of reporting sites per monomer:

E=I_{δ+}/2

the presence of isolated comonomer units is corrected for based on the number of isolated comonomer units present:

Etotal=E+(3*B+2*H)/2

where B and H are defined for their respective comonomers. Correction for consecutive and non-consecutive commoner incorporation, when present, is undertaken in a similar way.

Characteristic signals corresponding to the incorporation of 1-butene were observed and the comonomer fraction calculated as the fraction of 1-butene in the polymer with respect to all monomer in the polymer:

fBtotal=(Btotal/(Etotal+Btotal+Htotal)

The amount isolated 1-butene incorporated in EEBEE sequences was quantified using the integral of the _{*}B2 sites at 38.3 ppm accounting for the number of reporting sites per comonomer:

B=I_{*B2}

The amount consecutively incorporated 1-butene in EEBBEE sequences was quantified using the integral of the ααB2B2 site at 39.4 ppm accounting for the number of reporting sites per comonomer:

BB=2*IααB2B2

The amount non consecutively incorporated 1-butene in EEBEBEE sequences was quantified using the integral of the ββB2B2 site at 24.7 ppm accounting for the number of reporting sites per comonomer:

BEB=2*IββB2B2

Due to the overlap of the *B2 and *βB2B2 sites of isolated (EEBEE) and non-consecutively incorporated (EEBEBEE) 1-butene respectively the total amount of isolated 1-butene incorporation is corrected based on the amount of non-consecutive 1-butene present:

B=I_{*B2}−2*I_{ββB2B2}

The total 1-butene content was calculated based on the sum of isolated, consecutive and non consecutively incorporated 1-butene:

Btotal=B+BB+BEB

The total mole fraction of 1-butene in the polymer was then calculated as:

fB=(Btotal/(Etotal+Btotal+Htotal)

Characteristic signals corresponding to the incorporation of 1-hexene were observed and the comonomer fraction calculated as the fraction of 1-hexene in the polymer with respect to all monomer in the polymer:

fHtotal=(Htotal/(Etotal+Btotal+Htotal)

The amount isolated 1-hexene incorporated in EEHEE sequences was quantified using the integral of the _{*}B4 sites at 39.9 ppm accounting for the number of reporting sites per comonomer:

H=I_{*B4}

The amount consecutively incorporated 1-hexene in EEHHEE sequences was quantified using the integral of the ααB4B4 site at 40.5 ppm accounting for the number of reporting sites per comonomer:

HH=2*IααB4B4

The amount non consecutively incorporated 1-hexene in EEHEHEE sequences was quantified using the integral of the ββB4B4 site at 24.7 ppm accounting for the number of reporting sites per comonomer:

HEH=2*IββB4B4

The total mole fraction of 1-hexene in the polymer was then calculated as:

fH=(Htotal/(Etotal+Btotal+Htotal)

The mole percent comonomer incorporation is calculated from the mole fraction:

B[mol %]=100*fB

H[mol %]=100*fH

The weight percent comonomer incorporation is calculated from the mole fraction:

B[wt %]=100*(fB*56.11)/((fB*56.11)+(fH*84.16)+((1−(fB+fH))*28.05))

H[wt %]=100*(fH*84.16)/((fB*56.11)+(fH*84.16)+((1−(fB+fH))*28.05))

### Rheological Properties:

### Dynamic Shear Measurements (Frequency Sweep Measurements)

The characterization of polymer melts by dynamic shear measurements complies with ISO standards 6721-1 and 6721-10. The measurements were performed on an Anton Paar MCR501 stress controlled rotational rheometer, equipped with a 25 mm parallel plate geometry. Measurements were undertaken on compression moulded plates using nitrogen atmosphere and setting a strain within the linear viscoelastic regime. The oscillatory shear tests were done at 190° C. applying a frequency range between 0.0154 and 500 rad/s and setting a gap of 1.2 mm.

In a dynamic shear experiment the probe is subjected to a homogeneous deformation at a sinusoidal varying shear strain or shear stress (strain and stress controlled mode, respectively). On a controlled strain experiment, the probe is subjected to a sinusoidal strain that can be expressed by

γ(t)=γ₀ sin(ωt) (1)

If the applied strain is within the linear viscoelastic regime, the resulting sinusoidal stress response can be given by

σ(t)=σ₀ sin(ωt+δ) (2)

where σ₀, and γ₀ are the stress and strain amplitudes, respectively; ω is the angular frequency; δ is the phase shift (loss angle between applied strain and stress response); t is the time.

Dynamic test results are typically expressed by means of several different rheological functions, namely the shear storage modulus, G′, the shear loss modulus, G″, the complex shear modulus, G*, the complex shear viscosity, η*, the dynamic shear viscosity, η′, the out-of-phase component of the complex shear viscosity, η″, and the loss tangent, tan η, which can be expressed as follows:

$$\begin{matrix}{G}^{′} = \frac{{σ}_{0}}{{γ}_{0}} cos δ [ Pa ] & ( 3 ) \\ {G}^{″} = \frac{{σ}_{0}}{{γ}_{0}} sin δ [ Pa ] & ( 4 ) \\ {G}^{*} = {G}^{′} + {iG}^{″} [ Pa ] & ( 5 ) \\ {η}^{*} = {η}^{′} - i {η}^{″} [ Pa \cdot s ] & ( 6 ) \\ {η}^{′} = \frac{{G}^{*}}{ω} [ Pa \cdot s ] & ( 7 ) \\ {η}^{″} = \frac{{G}^{′}}{ω} [ Pa \cdot s ] & ( 8 )\end{matrix}$$

Besides the above mentioned rheological functions one can also determine other rheological parameters such as the so-called elasticity index EI(x). The elasticity index EI(x) is the value of the storage modulus, G′, determined for a value of the loss modulus, G″, of x kPa and can be described by equation 9.

EI(x)=G′ for (G″=x kPa) [Pa] (9)

For example, the EI(5 kPa) is defined by the value of the storage modulus G′, determined for a value of G″ equal to 5 kPa.

The determination of so-called Shear Thinning Indexes is done, as described in equation 10.

$$SHI ( x / y ) = \frac{{Eta}^{*} for ( {G}^{*} = x kPa )}{{Eta}^{*} for ( {G}^{*} = y kPa )} [ Pa ] \qquad ( 10 )$$

For example, the SHI_{(2.7/210)} is defined by the value of the complex viscosity, in Pa·s, determined for a value of G* equal to 2.7 kPa, divided by the value of the complex viscosity, in Pa·s, determined for a value of G* equal to 210 kPa.

The values of storage modulus (G′), loss modulus (G″), complex modulus (G*) and complex viscosity (η*) were obtained as a function of frequency (ω).

Thereby, e.g. η*_{300 rad/s} (eta*_{300 rad/s}) is used as abbreviation for the complex viscosity at the frequency of 300 rad/s and η_{*0.05 rad/s} (eta*_{0.5 rad/s}) is used as abbreviation for the complex viscosity at the frequency of 0.05 rad/s.

The values are determined by means of a single point interpolation procedure, as defined by Rheoplus software. In situations for which a given G* value is not experimentally reached, the value is determined by means of an extrapolation, using the same procedure as before. In both cases (interpolation or extrapolation), the option from Rheoplus “Interpolate y-values to x-values from parameter” and the “logarithmic interpolation type” were applied.

Tensile test: The tensile test (flex modulus in machine, nominal strain at break and break stress) is measured at 23° C. according to ISO 527-3 (cross head speed 1 mm/min) on 40 μm film.

Gloss and haze: Gloss at 45° is measured in gloss units (GU) according to ASTM D2457 on a 40 micron film. Haze is measured in % according to ASTM D1003 on a 40 micron film.

Tear: Is measures in transverse direction (TD) and machine direction (MD) according to ISO 6383/2 on a 40 micron film.

Dart Drop Impact (DDI): Is measured on a 40 micron film according to ISO 7765-1 or ASTM D1709.

### EXAMPLES

### Catalyst Preparation

130 grams of a metallocene complex bis(1-methyl-3-n-butylcyclopentadienyl) zirconium (IV) dichloride (CAS no. 151840-68-5), and 9.67 kg of a 30% solution of commercial methylalumoxane (MAO) in toluene were combined and 3.18 kg dry, purified toluene was added. The thus obtained complex solution was added onto 17 kg silica carrier Sylopol 55 SJ (supplied by Grace) by very slow uniform spraying over 2 hours. The temperature was kept below 30° C. The mixture was allowed to react for 3 hours after complex addition at 30° C.

### Comparative Example

Into a 50 dm³ loop reactor 100 g/h propane and 0.2 g/h hydrogen were added. The operating temperature was 50° C. and operating pressure 57 bar. The single site catalyst prepared as disclosed above was continuously fed at a rate of 27.36 g/hour into the loop reactor.

The slurry was taken out of the reactor and transferred into a 150 dm³ loop reactor. The reactor was operated at 85° C. and 55 bar pressure. Additional ethylene, 1-butene, propane diluent and hydrogen were continuously introduced into the reactor so that the MFR₂ of the polymer was 2.7 g/10 min and the density of polymer was 939 kg/m³.

The slurry was transferred into a second 300 dm³ loop reactor. The reactor was operated at 85° C. and 54 bar pressure. Additional ethylene, 1-butene, propane diluent and hydrogen were continuously introduced into the reactor so that the MFR₂ of the polymer was 18 g/10 min and the density of polymer was 943 kg/m³.

The slurry was continuously withdrawn from the reactor to a flash stage where hydrocarbons were removed from the polymer. The polymer was then transferred into a gas phase reactor where the polymerisation was continued. The reactor was operated at 75° C. temperature and 20 bar pressure. Ethylene, hydrogen, 1-butene and 1-hexene were fed into the reactor to obtain such conditions that the MFR₂ of the polymer was 0.83 g/10 min and the density 902 kg/m³. The productivity of the catalyst was 3.8 kg/g catalyst.

The ratio between polymer amounts produced in the slurry loop reactor 1, the slurry loop reactor 2 and gas phase reactor 3 was 19.7:19.9:57.6 (the remainder being attributed to the pre-polymerization).

### Example 1

Into a 50 dm³ loop reactor 100 g/h propane and 0.2 g/h hydrogen were added. The operating temperature was 50° C. and operating pressure 57 bar. The single site catalyst prepared as disclosed above was continuously fed at a rate of 27.33 g/hour into the loop reactor.

The slurry was taken out of the reactor and transferred into a 150 dm³ loop reactor. The reactor was operated at 85° C. and 55 bar pressure. Additional ethylene, 1-butene, propane diluent and hydrogen were continuously introduced into the reactor so that the MFR₂ of the polymer was 1.0/10 min and the density of polymer was 928.5 kg/m³.

The slurry was transferred into a second 300 dm³ loop reactor. The reactor was operated at 85° C. and 54 bar pressure. Additional ethylene, 1-butene, propane diluent and hydrogen were continuously introduced into the reactor so that the MFR₂ of the polymer was 67 g/10 min and the density of polymer was 951 kg/m³.

The slurry was continuously withdrawn from the reactor to a flash stage where hydrocarbons were removed from the polymer. The polymer was then transferred into a gas phase reactor where the polymerisation was continued. The reactor was operated at 75° C. temperature and 20 bar pressure. Ethylene, hydrogen, 1-butene and 1-hexene were fed into the reactor to obtain such conditions that the MFR₂ of the polymer was 0.46 g/10 min and the density 902 kg/m³. The productivity of the catalyst was 3.8 kg/g catalyst.

The ratio between polymer amounts produced in the slurry loop reactor 1, the slurry loop reactor 2 and gas phase reactor 3 was 17.8:17.8:61.8 (the remainder being attributed to the pre-polymerization).

The polymer was then compounded in with 1500 ppm Calcium stearate and 3000 ppm Irganox B225 (mixture of organophophite and hindered phenolic antioxidant).

The properties of the compounded resin are given in Table 1, where also the reaction conditions for the production of the base resin are shown (the density and MFR values indicated in Table 1 are the ones for the overall product obtained after polymerization in one or more reactors).

The compounded material was formed into films. The test result of the films are given in Table 2.

TABLE 1
polymerization conditions:

| | | | Comparative |
|---|---|---|---|
| | Units | Example 1 | Example (CE) |
| Pre-polymerization | | | |
| Temperature | ° C. | 50 | 50 |
| Pressure | Bar | 57 | 57 |
| Slurry loop reactor 1 | | | |
| Temperature | ° C. | 85 | 85 |
| Pressure | Bar | 55 | 55 |
| C₂ concentration | mol % | 2.8 | 2.67 |
| H₂/C₂ ratio | mol/kmol | 0.57 | 0.34 |
| C₄/C₂ ratio | mol/kmol | 171.2 | 66.5 |
| Split | wt-% | 17.8 | 19.7 |
| MFR₂ | g/(10 min) | 1.0 | 2.7 |
| Density | kg/m³ | 928.5 | 939 |
| Comonomer | 1-butene | 1-butene | |
| Slurry loop reactor 2 | | | |
| Temperature | ° C. | 85 | 85 |
| Pressure | Bar | 54 | 54 |
| C₂ concentration | mol % | 2.62 | 2.36 |
| H₂/C₂ ratio | mol/kmol | 0.44 | 0.25 |
| C₄/C₂ ratio | mol/kmol | 82.0 | 113.4 |
| Split | wt-% | 17.8 | 19.9 |
| MFR₂ | g/(10 min) | 8.2 | 7.0 |
| Density | kg/m³ | 940 | 941 |
| Comonomer | | 1-butene | 1-butene |
| Gas phase reactor 3 | | | |
| Temperature | ° C. | 75 | 75 |
| Pressure | Bar | 20 | 20 |
| H₂/C₂ ratio | mol/kmol | 0.11 | 0.18 |
| C₄/C₂ ratio | mol/kmol | 0 | 0 |
| C₆/C₂ ratio | mol/kmol | 31.8 | 32.9 |
| Split | wt-% | 61.8 | 57.6 |
| Comonomer | | 1-hexene | 1-hexene |
| Density final resin | kg/m³ | 916 | 918 |
| MFR2 final resin | g/10 min | 1.0 | 1.7 |

40 μm films were produced with 1:3 blow up ratio (BUR) and 120 mm frost line distance (FLD) on a Collin 30 blown film line with a melt temperature of 192° C. and a screw speed of 95 rpm and a take off speed of 6.3 m/min.

TABLE 2

| | Example 1 | CE |
|---|---|---|
| MD tensile | 175.6 | 250.1 |
| modulus (MPa) | | |
| MD nominal | 594.8 | 671 |
| tensile strain at | | |
| break (%) | | |
| MD break stress | 57.9 | 49.6 |
| MPa) | | |
| MD relative tear | 129.5 | 159.2 |
| resistance (N/mm) | | |
| TD relative tear | 158.7 | 183.8 |
| resistance (N/mm | | |
| Dart Drop Impact | 1617 | 756 |
| (impact failure | | |
| weight in g) | | |
| Gloss at 45° (GU) | 33.7 | 17.9 |
| Haze (%) | 20.1 | 35 |

As one can see, toughness as measured by DDI is significantly improved for Example 1 over the comparative example CE, while stiffness as measured by tensile modulus remains on a good level. Similarly, optical properties such as gloss and haze are improved. In addition, also break stress is improved.

1. A process for producing a polymer characterized in that a first ethylene polymer component (A) is obtained in a first polymerization zone by polymerization conducted in slurry in the presence of ethylene and hydrogen and the polymerization of a second ethylene polymer component (B) in a second polymerization zone is preferably conducted in gas phase in the presence of ethylene and a comonomer, to produce (a) a multimodal polymer of ethylene with at least one comonomer selected from alpha-olefins having from 4 to 10 carbon atoms,
which has
a) MFR₂ of 0.5 to 10 g/10 min (according to ISO 1133 at 190° C. under 2.16 kg load),
b) MFR₂₁/MFR₂ of 13 to 35 (MFR₂₁ at 190° C. under 21.6 kg load) and
c) MWD of 5 or less;
which comprises at least
an ethylene polymer component (A) and
an ethylene polymer component (B),
and wherein the MFR₂ of the ethylene polymer component (A) is higher than the MFR₂ of the ethylene polymer component (B) and the MFR₂ of of the ethylene polymer component (B) is <0.64 g/10 min according to ISO 1133 at 190° C. under 2.16 kg load.

2. A process for producing a polymer according to claim 1, characterized in that the first ethylene polymer component (A) is obtained in a first polymerization zone by polymerization conducted in slurry in the presence of a second comonomer and/or in that the process is for producing a polymer for film applications, especially for film applications demanding high toughness and/or good optical properties and/or in that at least one or preferably at least two or preferably all of the fractions (A) and/or (B) and/or the multimodal polymer (a) may have for example a MWD=Mw/Mn determined by GPC of 1.5 to 6.5, preferably 2 to 5.5, further preferred >2 to <5 or <4.5.

3. A process for producing a polymer according to claim 1 or 2, characterized in that the first polymerization zone comprises at least one slurry loop reactors and the second polymerisation zone comprises at least one gas phase reactor, preferably connected in series.

4. A process for producing a polymer according to any of the preceeding claims, characterized in that the first polymerization zone comprises two slurry loop reactors, preferably connected in series and/or in that the ratio of second comonomer to ethylene in the first loop is higher than in the second loop.

5. A process for producing a polymer according to claim 4 characterized in that the first polymerization zone comprises two slurry loop reactors connected in series, whereby hydrogen is added to the first slurry loop reactor and/or the second loop reactor, preferably only to the first loop reactor.

6. A process for producing a polymer according to claim 4 or 5 characterized in that the first polymerization zone comprises two slurry loop reactors connected in series, whereby hydrogen is fed only to the first slurry loop reactor and both slurry loops reactors are otherwise run under the same conditions or different conditions, preferably under the same conditions.

7. A process for producing a polymer according to any of the preceeding claims characterized in that the polymerization of a second ethylene polymer component (B) in a second polymerization zone is preferably conducted in gas phase, so that the molecular weight is maximized and/or in the with no hydrogen fed to the second polymerization zone and/or with H2/C2 ratio in mol/kmol of >0 to <0.15.

8. A process for producing a polymer according to any of the preceeding claims, wherein the ethylene polymer component (A) has a MFR₂ of 1 to 50 g/10 min, preferably of 1 to 40, more preferably of 1 to 30 g/10 min, more preferably 2 to 15 g/10 min or wherein the ratio of the MFR₂ of ethylene polymer component (A) to the MFR₂ of the final multimodal polymer of ethylene (a) is of 2 to 50, preferably of 5 to 40, preferably of 6 or 10 to 20 or 30.

9. A process for producing a polymer according to any of the preceeding claims, wherein a second comonomer is used to obtain polymer component (A) and the comonomer and the second comonomer are at least two alpha-olefin comonomers having from 4 to 10 carbon atoms, preferably 1-butene and 1-hexene, further preferred wherein the alpha-olefin comonomer having from 4 to 10 carbon atoms of ethylene polymer component (A) is different from the alpha-olefin comonomer having from 4 to 10 carbon atoms of ethylene polymer component (B), preferably wherein the second alpha-olefin comonomer having from 4 to 10 carbon atoms of ethylene polymer component (A) is 1-butene and the alpha-olefin comonomer having from 4 to 10 carbon atoms of ethylene polymer component (B) is 1-hexene.

10. A process for producing a polymer according to any of the preceeding claims, wherein the ratio of [the amount (mol %) of alpha-olefin comonomer having from 4 to 10 carbon atoms comonomer present in ethylene polymer component (A)] to [the amount (mol %) of at least two alpha-olefin comonomers having from 4 to 10 carbon atoms of the final multimodal polymer of ethylene (a)] is of 0.1 or 0.2 to 0.6, preferably of 0.24 to 0.5, more preferably the ethylene polymer component (A) has lower amount (mol %) of comonomer than the ethylene polymer component (B).

11. A process for producing a polymer according to any of the preceeding claims, wherein the amount (mol %) of alpha-olefin comonomer having from 4 to 10 carbon atoms present in the ethylene polymer component (A) is of 0.03 to 5.0 mol %, preferably of 0.05 to 4.0, more preferably of 0.1 to 3.0, even more preferably of 0.1 to 2.0, mol %.

12. A process for producing a polymer according to any of the preceeding claims, wherein the multimodal polymer of ethylene (a) is further multimodal with respect to density, preferably the density of the ethylene polymer component (A) is different, preferably higher, than the density of the ethylene polymer component (B).

13. A process for producing a polymer according to any of the preceeding claims, wherein the density of the ethylene polymer component (A) is of 925 to 950, preferably of 930 to 945, kg/m³ and/or wherein the density of the multimodal polymer of ethylene (a) is of 910 to 935, preferably of 915 to 930 or >912 to <925 and/or wherein the multimodal polymer of ethylene (a) has MFR₂₁/MFR₂ of 13 to 30, preferably 15 to 30, and/or wherein the multimodal polymer of ethylene (a) is multimodal with respect to MFR, type of the comonomer, comonomer content and density and/or wherein the multimodal polymer of ethylene (a), has a the tensile modulus in machine direction (MD) of 150 to 400 MPa, preferably 170 to 200 MPa or 200 to 350 MPa, preferably 210 to 330 MPa, when determined according to ISO 527-1 and ISO 527-3 and measured from a film sample (40 μm thickness) consisting of the polymer composition as described in the specification under “Determination methods” and/or wherein polymer composition, preferably the multimodal polymer of ethylene (a), has a SHI_{2.7/210} of 1.5 to 7, preferably of 2 to 3.5, when determined according to the “Dynamic Shear Measurements” as defined in the specification under Determination methods and/or wherein the polymercomposition has a gloss at 45° as determined of >20 to 50, preferably 25 to 45, further preferred >30 to <40 and/or wherein the polymer composition has a DDI of between 1000 and 2500 g, preferably between 1500 and 2000 g and/or wherein the polymer composition has a haze of 0 to <30, preferably >0 to <25 and/or wherein the polymer composition has break stress in machine direction (MD) of 50 to 70, preferably <50 to 65 MPa.

14. A process for producing a polymer according to any of the preceeding claims, wherein the multimodal polymer of ethylene (a) is produced using a single site catalyst, preferably wherein the ethylene polymer components (A) and (B) of the polymer of ethylene (a) are produced using same single site catalyst.

15. An article or film comprising the polymer composition produced using a process according to any of the preceding claims 1 to 14.
